(19) United States
(12) Patent Application Publication
(10) Pub. No.: US 2006/0026046 A1
(43) Pub. Date: Feb. 2, 2006

(54) Method for affording preferential status to selected suppliers each in a respective service industry category

(76) Inventors: Nir Yaron, Petah Tiqvah (IL); Ziv Ben Yehuda, Rishon Le'Ziyon (IL); Tal Shem Tov, Petah Tiqvah (IL)

Correspondence Address: NATH & ASSOCIATES, 1030 15th STREET, NW, 6TH FLOOR, WASHINGTON, DC, 20005, US

(21) Appl. No.: 10/901,434

(22) Filed: Jul. 29, 2004

(51) Int. Cl. G06F 9/44

(52) U.S. Cl. 705/7; 705/26

(57) ABSTRACT

A method for affording preferential status to selected suppliers each in a respective service industry category, the service industry category being included in a group of service industry categories. The method includes selecting at least one preferential status supplier each from a respective service industry category. The method also includes entering data corresponding to each selected preferential status supplier into a preferred suppliers database, and offering at least parts of the database for loading into a portable device. The portable device has a selector for selecting a desired service industry category for accessing the at least one preferential status supplier relating thereto.

### FIELD OF THE INVENTION

This invention relates to affording preferential status to selected suppliers each in a respective service industry category.

### BACKGROUND OF THE INVENTION

Traveling people (hereinafter, “travelers”) sometimes require services provided to them in their current location. Examples of such services are dental services, taxi or even food such as pizza. However, the traveler, being a stranger in an unfamiliar place, can find it difficult to locate a supplier to provide the required service. The problem is even harder to solve when the traveler gets to a place where he does not speak the language. Not speaking the language complicates things because an option such as searching in a local telephones directory (e.g., yellow pages) is not feasible.

Currently there are known methods for retrieving information about items (such as businesses and stores). For example, U.S. Pat. No. 6,415,291 (“System and methods for remotely accessing a selected group of items of interest from a database”, Lincoln et al., published on 2002) discloses a method according to which a user can access a common database from a remote communications port, at any qualified location, to generate a map or other positional information which locates selected items of interest, e.g., businesses, stores, architectural sites, and the like. The database contains information representing the items of interest, including, for each of the items of interest, positional coordinates, geographic vicinity, and a selected category. An advertisement can be tagged to the display or print out as an association with the selected items of interest.

Many people nowadays carry portable devices such as PDAs (Personal Digital Assistant) and other handhelds. U.S. Pat. No. 6,587,835 (“Shopping assistance with handheld computing device”, Treys et Treys, published on 2003) discloses a system in which a handheld computing device may be used to provide a user with shopping assistance services. The shopping assistance service disclosed in U.S. Pat. No. 6,587,835 may allow a user to obtain directory information for a shopping mall, and the user may use the handheld computing device to handle shopping lists. The handheld computing device may display promotional material based on the shopping lists or it may be used to obtain information on products being sold in a store. The location of the handheld computing device may be monitored and services may be provided to the user based on the location of the handheld computing device.

According to U.S. 2004/0058,710 (“Technique for synchronizing data in user devices through an information service”, Timmins et al., published on 2004), a user may utilize a communication device, e.g., a wireless phone, mobile device or personal digital assistant (PDA), to access an information assistance system where an operator may provide personalized information and communications services to the user. The information assistance system may provide an information management service for maintaining personal contacts folders (also known as “private directories”) and appointments folders for a user.

WO 01/13069 (“Method and apparatus for providing location-dependent services to mobile users”, Collier et al., Published on 2001), discloses a method and apparatus for allowing a mobile processing device, such as a cellular telephone, notebook computer, automobile navigation system, PDA, PIM, etc., to access location- or time-dependent information maintained by a central server. The server receives from the mobile device a transmitted signal that represents a user input applied at the mobile device and specifying an item in a database of the mobile device, such as a contact list. The signal corresponding to the selected item is transmitted by the mobile device to the server. The server computes location- or time-dependent information based on the signal and geocoded data in the server system. The location- or time-dependent information may comprise a geographic location, which may include a solution of a geographic proximity search, or information for assisting a driver in navigating an automobile. According to WO 01/13069, the geocoded data may be generated dynamically in response to the query from the mobile device.

It thus emerges that mobile devices that access location-dependent information are known. However, it is not apparent that it has been proposed to use such devices as a vehicle for affording preferential status to selected suppliers whereby a user seeking a supplier in a specific category of service industry is directed to one preferred supplier.

### SUMMARY OF THE INVENTION

The present invention provides a method for affording preferential status to selected suppliers each in a respective service industry category, said service industry category being included in a group of service industry categories, the method comprising:
(a) selecting at least one preferential status supplier each from a respective service industry category;
(b) entering data corresponding to each selected preferential status supplier into a preferred suppliers database, said data being in association with the respective service industry category; and
(c) offering at least parts of said database for loading into a portable device having a selector for selecting a desired service industry category for accessing the at least one preferential status supplier.

The present invention further provides a method for obtaining details relating to selected suppliers having preferential status each in a respective service industry category, said service industry category being included in a group of service industry categories, the method comprising:
(a) selecting a service industry category;
(b) accessing a preferred suppliers database for extracting therefrom details relating to at least one preferential status supplier stored therein in respect of the selected service industry category; and
(c) renderring said details.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 illustrates a system for providing directory of suppliers to portable devices, according to one embodiment of the invention;

FIG. 2 is a flowchart illustrating transmitting data stored in a directory server, according to an embodiment of the invention;

FIG. 3 is a schematic illustration of a selector allowing selection of data to be displayed according to a display criterion, according to an embodiment of the invention;

FIG. 4 is a flowchart illustrating selecting and transmitting data according to a loading criterion in a directory server, according to an embodiment of the invention;

FIG. 5 is a flowchart illustrating affording preferential status to selected suppliers each in a respective service industry category, according to an embodiment of the invention; and

FIG. 6 is a flowchart illustrating obtaining data relating to selected suppliers having preferential status each in a respective service industry category, according to an embodiment of the invention.

### DETAILED DESCRIPTION OF EXEMPLARY EMBODIMENTS

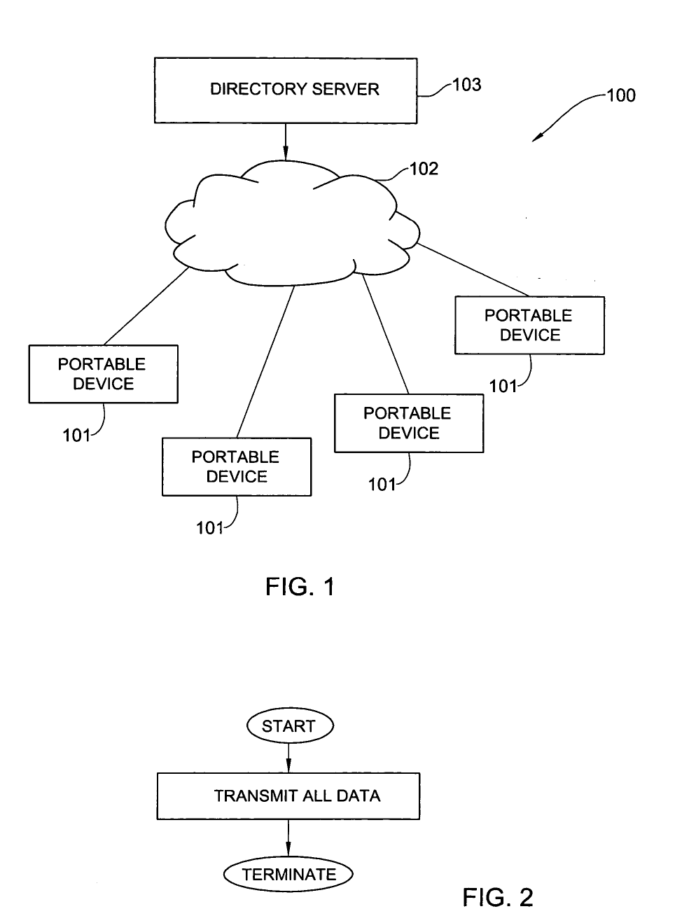

FIG. 1 is a schematic representation of a system 100 for selecting and transmitting data according to a loading criterion in a directory server, according to an embodiment of the invention. The system 100 comprises a plurality of portable devices 101 coupled via communications network 102 such as a cellular network, to a directory server 103, which can upload information to the portable devices 101. The portable devices 101 may be PDAs (Personal Digital Assistant, e.g., Palm, Visor, iPAQ and others.) A directory of suppliers, each in a respective service industry category (or shortly, “category”) is compiled on the directory server 103 and transmitted to the portable devices 101 to be loaded thereon for display.

A directory service provider (or shortly, “directory provider”) can afford information relating to suppliers (this information being referred to, hereinafter, as “service information”) to carriers of portable devices. According to one embodiment of the invention, the directory provider can compile service information to form, for example, records in a database stored in the directory server 103. The database can include records, each including at least a category (such as food, transportation, medical assistance etc.) and provider's details (such as the provider name, his address and/or telephone number). According to this embodiment a supplier can have a separate record for different locations where his services are offered.

FIG. 2 is a flowchart illustrating transmitting data stored in a directory server 103, according to an embodiment of the invention. As was previously mentioned with reference to FIG. 1, the directory provider compiles a database of suppliers on the directory server and then offers data from the database to owners of portable devices, to be loaded into their devices. According to one embodiment illustrated in the figure, all data stored in the database is loaded into the portable devices. According to this embodiment, a selector is installed on the portable devices. The selector allows selection of a certain record from amongst the loaded records, in accordance with a display criterion such as a category. Other display criteria are allowed as well, such as language.

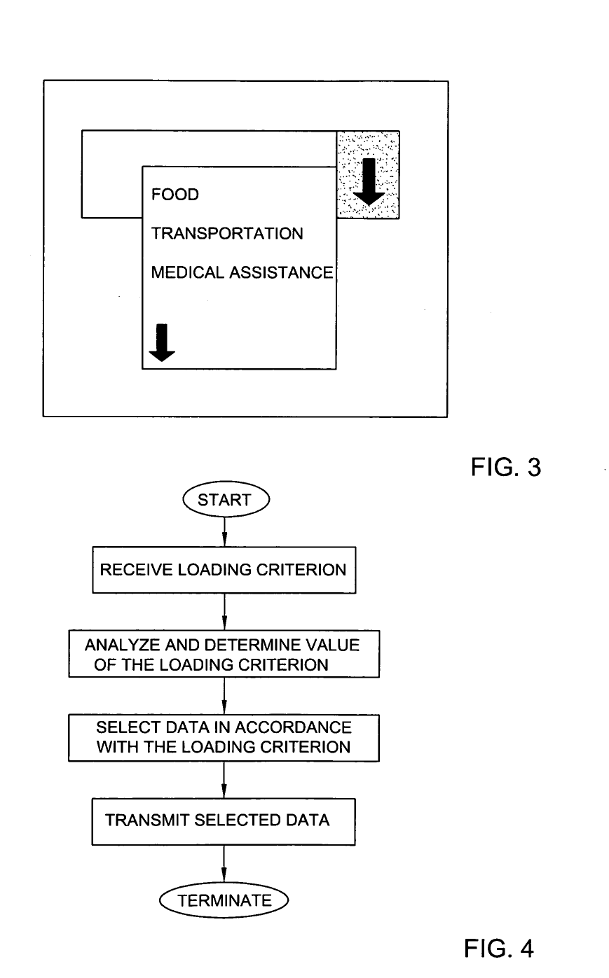

FIG. 3 is a schematic illustration of a selector allowing selection of data to be displayed according to a display criterion, according to an embodiment of the invention. The display criterion in FIG. 3 is the service industry category, wherein “Food”, “Transportation” and “Medical assistance” are used as exemplary categories, it being appreciated that other categories can be used as well or instead, such as “Laundry services”, “Legal consulting”, etc.

According to a different embodiment illustrated in FIG. 4, the directory server 103 selects part of the data stored therein for transmitting to the portable devices. The data is selected by the directory server according to a loading criterion. Examples of loading criteria are geographical location of a portable device to which data is to be loaded, or the language in which the portable device's carrier wishes to view data in (hereinafter, “interface language”).

The directory server receives the loading criterion, analyzes the loading criterion to determine its type and then determines its value. The loading criterion may be communicated to the directory server in different ways. Thus, according to one embodiment, before loading data, the portable device transmits the value of a loading criterion to the directory server. According to a different embodiment it is possible to receive the loading criterion by reading it from a storage device accessible to the directory server or by determining it in accordance with a set of logical conditions. This latter embodiment allows selections such as “if the portable device is connected to a cellular communication network of cellular provider X, let loading criterion be interface language and let interface language be Chinese”. That is, the loading criterion in this example is language=Chinese, wherein ‘language’ is the criterion's type and ‘Chinese’ is its value. A different example considers geographical location. Knowing that a certain portable device is currently located in New York, it is unnecessary to transmit to it data related to suppliers in Tokyo. In this case the following exemplary logical condition can be applicable: “let loading criterion be geographical location, let geographical location be portable device's location”. That is, the loading criterion in this example is location=portable device's location. It is appreciated that combined loading criteria (such as a criterion combining interface language and location) are also allowed.

It should be noted that portable devices having a GPS (Global Positioning System) receiver, for example, can extract their location therefrom and transmit to the directory server. Alternatively, the location of a portable device connected to a mobile telephone network (such as a cellular network) can be identified as well, as known to those versed in the art. Yet another alternative is asking the owner of the portable device to indicate his new location whenever he travels to a new destination.

Reverting back to FIG. 4, after analyzing and determining the value of the loading criterion, the directory server selects data that corresponds with the loading criterion and transmits the selected data to be loaded into the portable device.

There now follows an example of records belonging to different suppliers in a directory server. According to this example, an (imaginary) company named “FoodFast” has two branches, where hamburgers, sea food and other kinds of fast food are provided to customers. One branch is located at 105E Beef Street, Cow Town, Buffalo, United Meat Republic, Telephone number: +999-5-000000. The other branch is in 73 Salmon St., Fin Terra, Democratic Whales Kingdom, Telephone number: +333-7-111111. It is noted that the language spoken in the United Meat Republic is “Carnegian”, while in the Democratic Whales Kingdom the spoken language is “Finlang”.

Naturally, each supplier provides services to his customers in at least one certain language (hereinafter, “service language”). As can be assumed in the example above, FoodFast in Cow Town employs Carnegian speaking personnel while the Fin Terra branch provides services in Finlang. Yet, apart from Finlang speaking personnel, FoodFast in Fin Terra employs one man who speaks Carnegian and one woman who speaks a different language called “Stamish”. Therefore, the Fin Terra branch can easily offer services to foreigners who speak these languages, i.e., Carnegian and Stamish are also considered as service languages of the Fin Terra branch. Unlike the Fin Terra branch, which provides multi-language services, Cow Town's branch's only service language is Carnegian.

According to the example and the described embodiment above, the directory service provider compiles a database including two records:
(1) Category: food
   Supplier's name: FoodFast
   Address: 105E Beef Street, Cow Town, Buffalo
   Country: United Meat Republic
   Telephone: +999-5-000000
   Service language: Carnegian
(2) Category: food
   Supplier's name: FoodFast
   Address: 73 Salmon St., Fin Terra
   Country: Democratic Whales Kingdom
   Telephone: +333-7-111111
   Service language: Finlang, Carnegian, Stamish

One versed in the art will appreciate that other information is allowed as well, such as email address, facsimile number, contact person's name etc. and that information can be organized in different fields.

It should also be appreciated that there is no connection or correlation between the suppliers' respective service languages and the interface languages offered by a directory service provider. For example, the directory service provider can offer the information in four different interface languages, such as English, Finlang, Stamish, and another language called Sushian. This is regardless of the fact that in the database are listed suppliers offering services in Carnegian as the service language, yet, currently there is no supplier providing services in Sushian.

In those cases when more than one interface language is supported, each record can be duplicated to appear at least in some of the supported interface languages. According to the example above, FoodFast's branch in Cow Town can have one record in English (as illustrated above), and a second, duplicated record in Stamish that is equivalent to the illustrated English record, but the information in it is stored in Stamish as the interface language. Alternatively, a record can include duplicate fields for the different languages. This way, instead of having two records for FoodFast in Cow Town, there will be only one record for this branch, including duplicated fields. Other methods known per se for multi-language support are allowed as well.

Before continuing with the description of additional embodiments of the invention, the example above is added another (imaginary) fast food supplier in Cow Town. This supplier's name is FoodGood and he is a competitor of FoodFast's branch in Cow Town. Unlike FoodFast, FoodGood has only one branch, whose record information is as follows:
Category: food
Supplier's name: FoodGood
Address: 12N Sheep Avenue, Cow Town, Buffalo
Country: United Meat Republic
Telephone: +999-5-222222
Service language: Carnegian, English, Sushian

Turning now to an embodiment of the invention, a directory provider can include in his directory a limited set of suppliers. The directory provider can have a group of service industry categories and only suppliers whose respective category is in the group can be listed in the directory provider's directory.

Yet, it is possible to limit the number of suppliers having a certain respective category that are allowed to be listed in the directory. This way, instead of including both FoodFast and FoodGood, the directory provider can opt to include in his directory only one supplier in the food category, that is, FoodFast or FoodGood. According to this embodiment, the chosen supplier is considered as having a preferential status, compared to the other suppliers in this category that are not included in the directory. Therefore, this supplier is referred to, hereinafter, as a “preferential status supplier”. Likewise, a directory including preferential status suppliers is referred to, hereinafter, as a “preferred suppliers' database”.

However, the number of preferential status suppliers in a respective category is not limited by the invention to one. Thus, a directory can include two, three or any other applicable number of preferential status suppliers in a certain category, and a different number of preferential status suppliers in a different category. Thus, the directory provider selects at least one preferential status supplier from a respective category. Furthermore, the directory provider can afford the preferential status to suppliers in a category, and select at least one preferential status supplier therefrom, according to one or more selection criteria.

For example, the selected preferential status suppliers can be those that are willing to pay more as service fees to the directory provider. That is, service fees can serve as a selection criterion. Alternatively, the directory provider can select the most popular provider, knowing that this will increase the popularity of the preferred suppliers' database among users, i.e. among portable device carriers. That is, popularity measure is yet another optional selection criterion. Other criteria are allowed as well, such as selecting preferential status suppliers in accordance to a survey conducted by the directory provider or by any other entity, wherein the survey's results can be considered as a measurement of quality.

It can be assumed, for example, that FoodGood offers to pay much higher service fees to the directory supplier, compared to FoodFast's Cow Town branch. Yet, knowing that FoodFast is a popular network having additional branches, and estimating the chances that FoodFast would list additional branches in the preferred suppliers' database raises if its Cow Town's branch will be listed instead of FoodGood, the directory provider can select FoodFast as its preferential status supplier in the food category instead of FoodGood.

It should be appreciated that other selection criteria are also allowed. For example, geographical location, interface language and/or service language can be used as selection criteria. This way, the directory provider can select FoodFast as the preferential status supplier, instead of selecting FoodGood, because FoodFast is represented world wide unlike FoodGood. Alternatively he can select FoodGood to be the preferential status supplier in Cow Town because their offered service fees are higher, while FoodFast can be selected as the preferential status supplier in Fin Terra just because they have a branch there and the directory provider wishes to penetrate the Fin Terra market. In this case, FoodFast's geographical location (in Fin Terra) is the selection criterion.

According to a different example, after selecting FoodFast as a preferential status supplier in Cow Town, the directory provider can select FoodGood as a second preferential status supplier there (assuming that the provider's contract with FoodFast allows this), because FoodGood's service languages include also English and Sushian. It is also possible that while FoodFast's corresponding data is stored in the preferred suppliers' database in English, FoodGood's data will be displayed in Finlang and in Sushian, wherein the interface language is used as a selection criterion. It should be noted that a combination of different selection criteria are allowed as well.

After having described several examples for using different criteria as a selection criterion, it should be also appreciated that the directory provider can offer for tender to become a preferential status supplier to suppliers in a respective category.

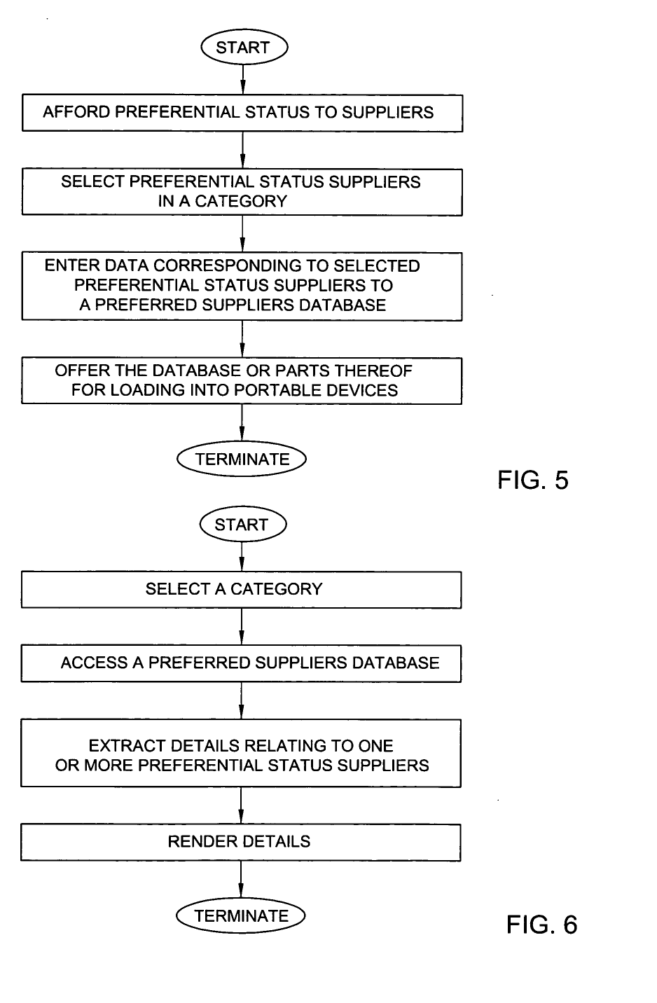

FIG. 5 is a flowchart illustrating affording preferential status to selected suppliers each in a respective service industry category, according to an embodiment of the invention. The directory provider affords preferential status to suppliers in a certain respective service industry category, for example by directly proposing to them to join the directory service or by selling the preferential status by offering it for tender. From amongst these suppliers at least one preferential status supplier is selected in the category, and data corresponding to these selected suppliers is entered to the preferred suppliers' database.

It should be noted that the corresponding data is entered in any required interface language. Alternatively, if multi-language support requires that data should be entered in one language only, wherein translation is later performed automatically, for example, and data should be included in a limited set of one or more interface languages out of the interface languages supported by the preferred suppliers' database, a proper indication should be associated with the data, such as a flag as known to those versed in the art.

The preferred suppliers' database and/or parts thereof are then offered for loading into portable devices in a method known per se.

It should be appreciated that users carrying portable devices can install a software application on their portable devices, such as a viewer for displaying data stored in the loaded preferred suppliers' database. Alternatively, the software application can provide details by playing audio, by printing data using a printer or by any alternative way of rendering the details as known per se. In order to install the software application, a user can receive installation software by any method known per se, such as by downloading it from the Internet, or by getting access to a storage device wherein the viewer's installation software is installed. After installing the software application, the user can load a preferred suppliers' database to his portable device in order to retrieve data therefrom.

FIG. 6 is a flowchart illustrating obtaining details relating to selected suppliers having preferential status each in a respective service industry category, according to an embodiment of the invention. The service industry category being included in a group of service industry categories. For example, reference is made to FIG. 3, where an exemplary group of categories including “Food”, “Transportation” and “Medical assistance” is illustrated.

According to the embodiment, after selecting a service industry category from the group, the software application accesses a preferred suppliers database that was previously loaded to the portable device and extracts therefrom details relating to one or more preferential status suppliers whose respective service industry category is the selected category. The extracted details are rendered and provided to the user by the software application. Examples for such details are FoodFast's and FoodGood's records provided above.

A person versed in the art will understand that a preferred suppliers' database is subject to updates and/or modifications. For example, records of new preferred status suppliers can be inserted by the directory provider, while other records can be removed therefrom. Therefore, updates to a preferred suppliers' database loaded on to a portable device are sometimes required. The update can be performed by any method known per se.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

1. A method for affording preferential status to selected suppliers each in a respective service industry category, said service industry category being included in a group of service industry categories, the method comprising:
(a) selecting at least one preferential status supplier each from a respective service industry category;
(b) entering data corresponding to each selected preferential status supplier into a preferred suppliers database, said data being in association with the respective service industry category; and
(c) offering at least parts of said database for loading into a portable device having a selector for selecting a desired service industry category for accessing the at least one preferential status supplier.

2. The method according to claim 1, wherein the portable device has a display for displaying one of the respective at least one preferential status supplier.

3. The method according to claim 1, wherein selecting at least one preferential status supplier from each respective service industry category includes offering for tender to become a preferential status supplier to suppliers in each respective service industry category.

4. The method according to claim 1, wherein the at least one preferential status supplier from each respective service industry category is selected from a respective service industry category according to at least one predetermined selection criterion.

5. The method according to claim 4, wherein said selection criterion being included in a group including at least: geographical location, interface language, service language, service fees, popularity measures and a combination thereof.

6. The method according to claim 1, wherein said at least part of said database being offered for loading according to a loading criterion.

7. The method according to claim 6, wherein said loading criterion is included in a group including at least: geographical location, interface language and service language and a combination thereof.

8. The method according to claim 6, wherein the at least one loading criterion is received from said portable device.

9. The method according to claim 6, wherein the at least one loading criterion is predetermined.

10. The method according to claim 6, wherein the at least one loading criterion is received from calculating a logical condition.

11. A method for obtaining details relating to selected suppliers having preferential status each in a respective service industry category, said service industry category being included in a group of service industry categories, the method comprising:
(a) selecting a service industry category;
(b) accessing a preferred suppliers database for extracting therefrom details relating to at least one preferential status supplier stored therein in respect of the selected service industry category; and
(c) renderring said details.

12. The method according to claim 11, wherein rendering includes displaying.

13. The method according to claim 11, wherein rendering includes playing audio.

14. The method according to claim 11, wherein rendering includes printing.

15. A program storage device readable by machine, tangibly embodying a program of instructions executable by the machine to perform a method for affording preferential status to selected suppliers each in a respective service industry category, said service industry category being included in a group of service industry categories, the method comprising:
(a) selecting at least one preferential status supplier each from a respective service industry category;
(b) entering data corresponding to each selected preferential status supplier into a preferred suppliers database, said data being in association with the respective service industry category; and
(c) offering at least parts of said database for loading into a portable device having a selector for selecting a desired service industry category for accessing the at least one preferential status supplier.

16. A computer program product comprising a computer useable medium having computer readable program code embodied therein for affording preferential status to selected suppliers each in a respective service industry category, said service industry category being included in a group of service industry categories, the computer program product comprising:
computer readable program code for causing the computer to select at least one preferential status supplier each from a respective service industry category;
computer readable program code for causing the computer to enter data corresponding to each selected preferential status supplier into a preferred suppliers database, said data being in association with the respective service industry category; and
computer readable program code for causing the computer to offer at least parts of said database for loading into a portable device having a selector for selecting a desired service industry category for accessing the at least one preferential status supplier.
